(19) United States
(12) Patent Application Publication
(10) Pub. No.: US 2012/0086641 A1
(43) Pub. Date: Apr. 12, 2012

(54) MULTI-MODE FOLDABLE MOUSE

(75) Inventors: YU-MING CHIEN, Taipei (TW); HUNG-MING LIN, Taipei (TW); CHIN-PING CHAN, Taipei (TW)

(73) Assignee: PRIMAX ELECTRONICS LTD., Taipei (TW)

(21) Appl. No.: 12/951,229

(22) Filed: Nov. 22, 2010

(30) Foreign Application Priority Data
Oct. 8, 2010 (TW) 099134348

(51) Int. Cl. G06F 3/033

(52) U.S. Cl. 345/166

(57) ABSTRACT

A multi-mode foldable mouse includes a main body, a cover, a sensing device and a controller. A first touch panel is disposed on the main body. A second touch panel is disposed on the cover. The sensing device is used for sensing a position of the main body relative to the cover. The controller is used for controlling the mouse to be operated in either a multi-touch mode or a keyboard mode according to the position of the main body relative to the cover. When the mouse in operated in the multi-touch mode, the first touch panel is enabled, and a multi-finger inputting operation on the first touch panel is converted into an image control instruction. When the mouse in operated in a keyboard mode, a virtual standard keyboard is shown on the first touch panel in cooperation with the second touch panel for providing a function of inputting characters.

### FIELD OF THE INVENTION

The present invention relates to a multi-mode foldable mouse, and more particularly to a multi-mode foldable mouse for automatically switching the operating mode according to the position of a cover relative to a main body thereof.

### BACKGROUND OF THE INVENTION

With increasing development of science and technology, computers and peripheral devices thereof are designed in views of functionality, convenience and user-friendliness. For example, a mouse is one of the most common input devices. After the mouse is in communication with an electronic device (e.g. a personal computer), the movement of the cursor shown on the computer screen can be controlled without difficulty. However, the applications of the mouse are limited in some occasions. For example, in a case that the user wants to input a great amount of data, the user prefers using a keyboard in replace of the mouse. However, it is troublesome and inconvenient for a user to move his hand between the mouse and the keyboard to fulfill different tasks. For solving this drawback, an input device with dual functions of a mouse and a keyboard has been disclosed.

FIG. 1 is a schematic perspective view illustrating a conventional input device. The input device 1 of FIG. 1 is disclosed in for example Taiwanese Utility Model Patent No. 296423, which is entitled “Input device”. As shown in FIG. 1, the input device 1 comprises a base 10, a keyboard unit 12 and an operable part 111. The keyboard unit 12 is disposed on the base 10 and comprises plural keys 121. The operable part 111 is arranged at a sidewall 11 of the input device 1. When the operable part 111 is moved to a first position, the function of the keyboard unit 12 is disabled. In this situation, since the input device is operated in a cursor control mode as a common mouse, the keys 121 will not be erroneously triggered. However, since the operable part 111 is arranged at the sidewall 11 of the input device 1, if the operable part 111 is erroneously moved to a second position, the keyboard unit 12 will be enabled. Moreover, if the user forgets whether the keyboard unit 12 of the input device 1 is in an enabling state or a disabling state, the keyboard unit 12 may be erroneously operated. That is, the conventional input device is not user-friendly.

Therefore, there is a need of providing a multi-mode foldable mouse to obviate the drawbacks encountered from the prior art.

### SUMMARY OF THE INVENTION

The present invention provides a multi-mode foldable mouse that can be operated in a multi-touch mode or a keyboard mode.

In accordance with an aspect of the present invention, there is provided a multi-mode foldable mouse. The multi-mode foldable mouse includes a main body, a cover, a sensing device and a controller. The main body includes a main body inner surface and a main body outer surface. A first touch panel is disposed on the main body inner surface. The cover is rotatable with respect to the main body through a rotating shaft, and includes a cover inner surface and a cover outer surface. A second touch panel is disposed on the cover inner surface. The sensing device is used for sensing a position of the main body relative to the cover. The controller is used for controlling the mouse to be operated in either a first mode or a second mode according to the position of the main body relative to the cover. When the mouse is operated in the first mode, the first touch panel is enabled. Whereas, when the mouse is operated in the second mode, the first touch panel and the second touch panel are enabled.

In an embodiment, the mouse further includes a left button and a right button, which are disposed on the cover outer surface.

In an embodiment, the mouse further includes an optical sensing device, which is disposed within the main body for generating a cursor control signal. When the mouse in operated in the first mode or the second mode, the optical sensing device is disabled, so that the cursor control signal is not generated.

In an embodiment, the first mode is a multi-touch mode, and the second mode is a keyboard mode. When the mouse in operated in the first mode, a multi-finger inputting operation on the first touch panel is converted into an image control instruction. Whereas, when the mouse in operated in the second mode, an image of a virtual standard keyboard is shown on the first touch panel in cooperation with the second touch panel for providing a function of inputting characters.

In an embodiment, when the cover is closed to shelter the main body, the mouse is operated in a cursor control mode. When a first angle is defined between the main body and the cover, the mouse is operated in the first mode. Whereas, when a second angle greater than the first angle is defined between the main body and the cover, the mouse is operated in the second mode.

In an embodiment, the sensing device includes a first sensing unit and a second sensing unit. The first sensing unit is used for sensing whether the angle between the main body and the cover is the first angle. The second sensing unit is used for sensing whether the angle between the main body and the cover is the second angle.

In an embodiment, the first sensing unit includes a protrusion and a first switch corresponding to the protrusion. When the first switch is pressed by the protrusion, the optical sensing device is enabled to generate the cursor control signal. Whereas, when the first angle is defined between the main body and the cover, the protrusion and the first switch are separated from each other, so that the mouse is operated in the first mode.

In an embodiment, the second sensing unit includes a bulge, a triggering part and a second switch, and the bulge is disposed on the rotating shaft. When the second angle is defined between the main body and the cover, the bulge of the rotating shaft is sustained against the triggering part, so that the second switch is touched by the triggering part and the mouse is operated in the second mode.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating a conventional input device;

FIG. 2 is a schematic perspective view illustrating a multi-mode foldable mouse according to an embodiment of the present invention, in which the cover of the multi-mode foldable mouse is closed;

FIG. 3 is a schematic perspective view illustrating a multi-mode foldable mouse according to an embodiment of the present invention, in which the cover of the multi-mode foldable mouse is opened;

FIG. 4A is a schematic side view illustrating the multi-mode foldable mouse of the present invention, in which a first angle is defined between the main body and the cover;

FIG. 4B is a schematic side view illustrating the multi-mode foldable mouse of the present invention, in which a second angle is defined between the main body and the cover;

FIG. 4C is a schematic side view illustrating the multi-mode foldable mouse of the present invention, in which the cover of the multi-mode foldable mouse is closed;

FIG. 5A is a schematic view illustrating a way of performing a multi-finger inputting operation on the first touch panel when the mouse is operated in the multi-touch mode; and

FIG. 5B is a schematic view illustrating the image of a virtual standard keyboard shown on the first touch panel in cooperation with the second touch panel when the mouse is operated in the keyboard mode.

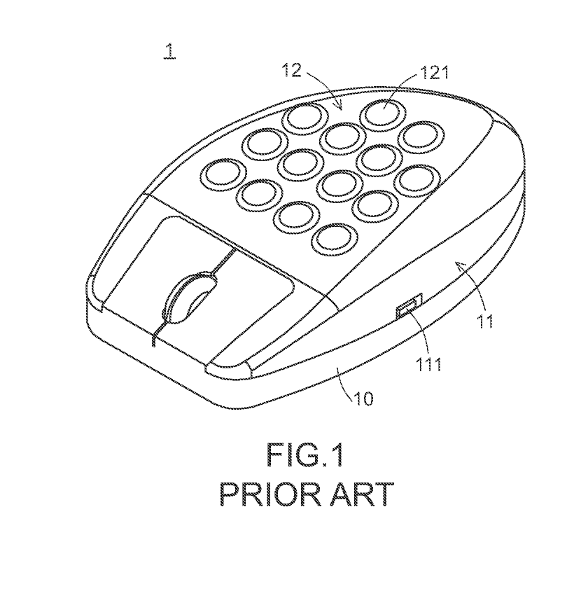

### DETAILED DESCRIPTION OF THE PREFERRED EMBODIMENT

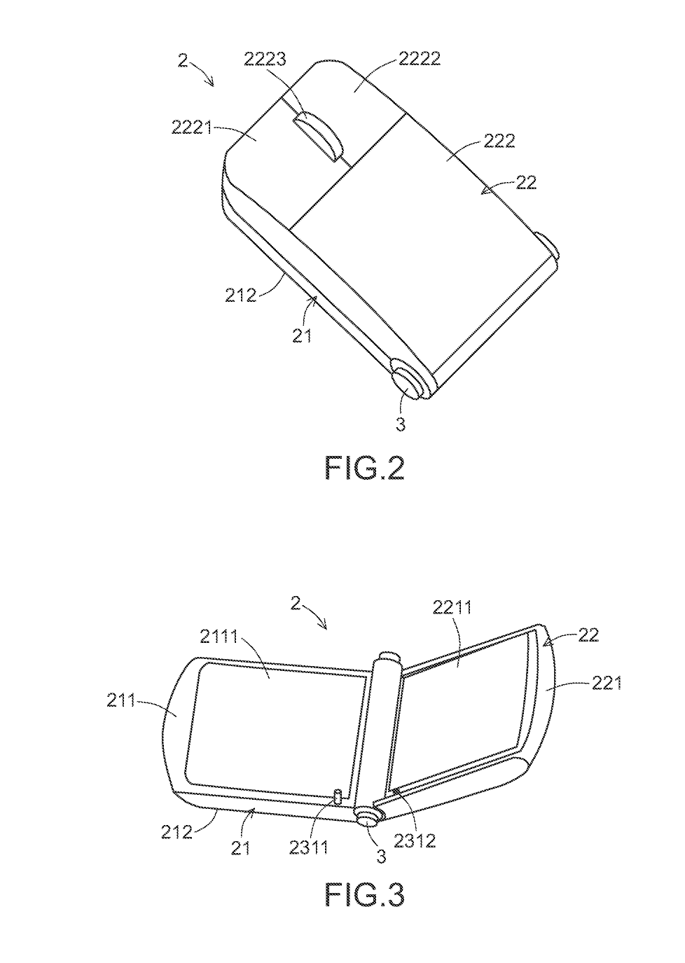

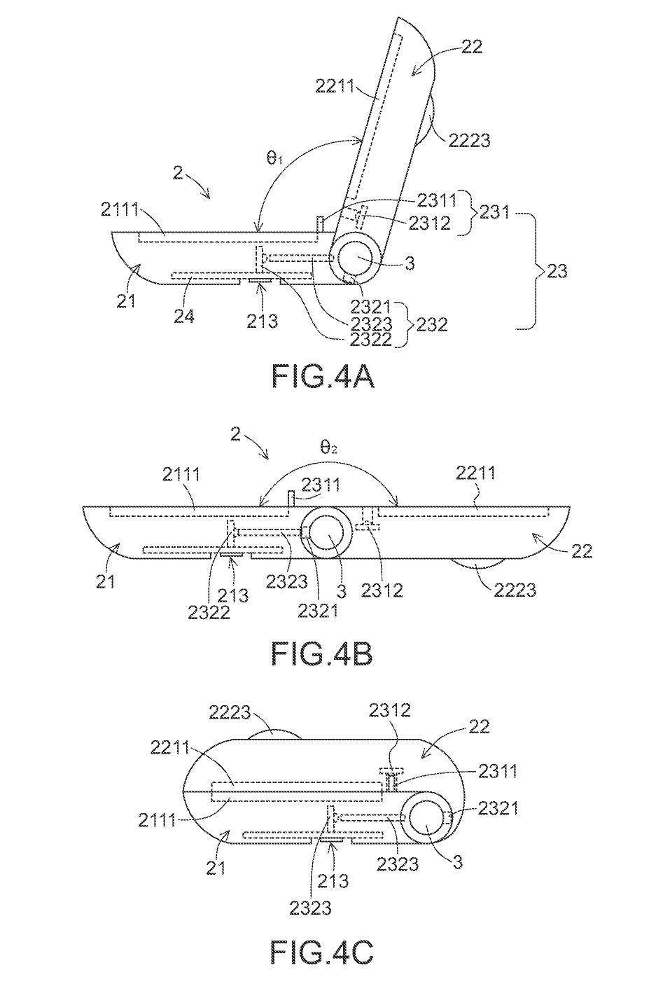

FIG. 2 is a schematic perspective view illustrating a multi-mode foldable mouse according to an embodiment of the present invention, in which the cover of the multi-mode foldable mouse is closed. FIG. 3 is a schematic perspective view illustrating a multi-mode foldable mouse according to an embodiment of the present invention, in which the cover of the multi-mode foldable mouse is opened. Please refer to FIGS. 2 and 3. The multi-mode foldable mouse 2 comprises a main body 21, a cover 22, a sensing device 23 and a controller 24 (see FIG. 4A). The main body 21 comprises a main body inner surface 211 and a main body outer surface 212. The cover 22 comprises a cover inner surface 221 and a cover outer surface 222. A first touch panel 2111 and a second touch panel 2211 are disposed on the main body inner surface 211 and the cover inner surface 221, respectively. In addition, a left button 2221, a right button 2222 and a scroll wheel 2223 are disposed on the cover outer surface 222. Through a rotating shaft 3, the cover 22 is rotatable with respect to the main body 21.

FIG. 4A is a schematic side view illustrating the multi-mode foldable mouse of the present invention, in which a first angle is defined between the main body and the cover. FIG. 4B is a schematic side view illustrating the multi-mode foldable mouse of the present invention, in which a second angle is defined between the main body and the cover. Please refer to FIGS. 4A and 4B. The sensing device 23 comprises a first sensing unit 231 and a second sensing unit 232. The first sensing unit 231 comprises a protrusion 2311 and a first switch 2312 corresponding to the protrusion 2311. The second sensing unit 232 comprises a bulge 2321, a triggering part 2323 and a second switch 2322. The bulge 2321 is disposed on the rotating shaft 3.

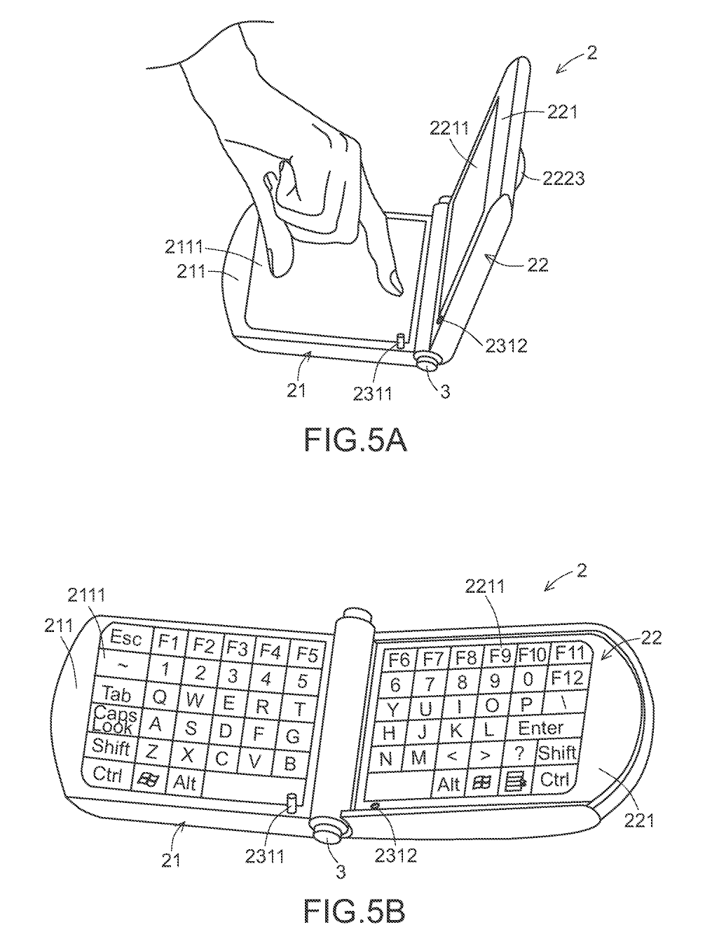

In a case that a first angle θ1 is between the main body 21 and the cover 22, the protrusion 2311 and the first switch 2312 are separated from each other. In this situation, the multi-mode foldable mouse 2 enters a multi-touch mode, and thus the first touch panel 2111 is enabled. In the multi-touch mode, if the plural fingers of the user are placed and moved on the first touch panel 2111 (see FIG. 5A), the multi-finger inputting operation on the first touch panel 2111 is converted into an image control instruction. The image control instruction is executed to control a process of zooming in, zooming out or rotating the image shown on the computer screen.

Please refer to FIG. 4B again. In a case that a second angle θ2 greater than the first angle θ1 is defined between the main body 21 and the cover 22, the bulge 2321 of the rotating shaft 3 is sustained against the triggering part 2323, so that the second switch 2322 is touched by the triggering part 2323. In this situation, the multi-mode foldable mouse 2 enters a keyboard mode. In the keyboard mode, the image of a virtual standard keyboard is shown on the first touch panel 2111 in cooperation with the second touch panel 2211. Via the virtual keyboard, the functions of inputting characters are achieved (see FIG. 5B).

FIG. 4C is a schematic side view illustrating the multi-mode foldable mouse of the present invention, in which the cover of the multi-mode foldable mouse is closed. If the user wants to operate the multi-mode foldable mouse 2 in a cursor control mode, the user may rotate the cover 22 to shelter the main body 21. In this situation, since the first switch 2312 is pressed and triggered by the protrusion 2311, an optical sensing device 213 within the main body 21 is enabled for providing the functions associated to the cursor control mode. In addition, a wireless transmitter (not shown) is installed within the main body 21. Through the wireless transmitter, a cursor control signal is transmitted to a computer. Alternatively, in some embodiments, the cursor control signal is not transmitted to the computer through the wireless transmitter, but the cursor control signal is transmitted to the computer through an electric cable (not shown).

From the above description, the operating mode of the multi-mode foldable mouse of the present invention can be automatically switched according to the position of the cover relative to the main body. As previously described, since the operating mode of the conventional input device is switched by manually adjusting the operable part, if the user forgets whether the keyboard unit of the input device is in an enabling state or a disabling state, the keyboard unit may be erroneously operated. That is, the conventional input device is not user-friendly. Whereas, since the virtual keyboard can be shown on the inner surface of the multi-mode foldable mouse of the present invention, if the mouse is operated in the cursor control mode, it is impossible to touch the keyboard. Moreover, the multi-mode foldable mouse of the present invention may be further operated in a multi-touch mode.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A multi-mode foldable mouse, comprising:
a main body comprising a main body inner surface and a main body outer surface, wherein a first touch panel is disposed on said main body inner surface;
a cover rotatable with respect to said main body through a rotating shaft, and comprising a cover inner surface and a cover outer surface, wherein a second touch panel is disposed on said cover inner surface;
a sensing device for sensing a position of said main body relative to said cover; and
a controller for controlling said mouse to be operated in either a first mode or a second mode according to said position of said main body relative to said cover, wherein when said mouse is operated in said first mode, said first touch panel is enabled, wherein when said mouse is operated in said second mode, said first touch panel and said second touch panel are enabled.

2. The multi-mode foldable mouse according to claim 1 wherein said mouse further comprises a left button and a right button, which are disposed on said cover outer surface.

3. The multi-mode foldable mouse according to claim 1 wherein said mouse further comprises an optical sensing device disposed within said main body and configured for generating a cursor control signal, wherein said optical sensing device is disabled on condition of said mouse operated in said first mode or said second mode, so that said cursor control signal is not generated.

4. The multi-mode foldable mouse according to claim 3 wherein said first mode is a multi-touch mode, and said second mode is a keyboard mode, wherein when said mouse is operated in said first mode, a multi-finger inputting operation on said first touch panel is converted into an image control instruction, wherein when said mouse is operated in said second mode, an image of a virtual standard keyboard is shown on said first touch panel in cooperation with said second touch panel for providing a function of inputting characters.

5. The multi-mode foldable mouse according to claim 1 wherein when said cover is closed to shelter said main body, said mouse is operated in a cursor control mode, wherein when a first angle is defined between said main body and said cover, said mouse is operated in said first mode, wherein when a second angle greater than said first angle is defined between said main body and said cover, said mouse is operated in said second mode.

6. The multi-mode foldable mouse according to claim 5 wherein said sensing device comprises:
a first sensing unit for sensing whether said first angle is defined between said main body and said cover; and
a second sensing unit for sensing whether said second angle is defined between said main body and said cover.

7. The multi-mode foldable mouse according to claim 6 wherein said mouse further comprises an optical sensing device disposed within said main body and configured for generating a cursor control signal, wherein said optical sensing device is disabled on condition of said mouse operated in said first mode or said second mode, so that said cursor control signal is not generated, and wherein said first sensing unit comprises a protrusion and a first switch corresponding to said protrusion, wherein when said first switch is pressed by said protrusion, said optical sensing device is enabled to generate said cursor control signal, and when said first angle is defined between said main body and said cover, said protrusion and said first switch are separated from each other, so that said mouse is operated in said first mode.

8. The multi-mode foldable mouse according to claim 6 wherein said second sensing unit comprises a bulge, a triggering part and a second switch, and said bulge is disposed on said rotating shaft, wherein when said second angle is defined between said main body and said cover, said bulge of said rotating shaft is sustained against said triggering part, so that said second switch is touched by said triggering part and said mouse is operated in said second mode.
